(19) United States
(12) Patent Application Publication
(10) Pub. No.: US 2015/0193379 A1
(43) Pub. Date: Jul. 9, 2015

(54) SYSTEM AND METHOD FOR COGNIZANT TIME-BASED REMINDERS

(71) Applicant: Apple Inc., Cupertino, CA (US)

(72) Inventor: Sarin S. MEHTA, Cupertino, CA (US)

(21) Appl. No.: 14/543,406

(22) Filed: Nov. 17, 2014

Related U.S. Application Data
(60) Provisional application No. 61/924,173, filed on Jan. 6, 2014.

(51) Int. Cl. G06F 17/21

(52) U.S. Cl. CPC G06F 17/21

(57) ABSTRACT

The computer-implemented method provides information relating to reminders. The method is performed at an electronic device comprising a processor and memory storing instructions for execution by the processor. A text string is received that corresponds to a natural language speech input received from a user. The text string is processed, using natural language processing, to determine that the text string includes a command to create a reminder item to remind the user at a certain time to perform a certain activity. In some embodiments, at least one service is identified that contains information that may affect performance of the certain activity at the certain time. At least one service then searched to locate information that may affect performance of the certain activity at the certain time.

### RELATED APPLICATIONS

This application claims priority to U.S. Provisional Patent Application No. 61/924,173, filed Jan. 6, 2014, which is incorporated herein in its entirety.

### TECHNICAL FIELD

This disclosure relates generally to digital assistants, and more specifically, to time-based reminders or to-do lists.

### BACKGROUND

These days, many smart-phones, such as Applicants' IPHONE, include a myriad of features in addition to the device's communication features. For example, such devices typically include at least email, messaging, calendar, notes, weather, and reminders. The reminder feature is typically time-based, and includes a reminder to-do or task list, where each task is associated with a respective date and time. At the appointed time, the device displays the task to the user to remind the user to perform the task. These reminders are displayed without any consideration given to the content of the reminder or the surrounding context. For example, a user may instruct the phone to remind her to purchase milk from the grocery store at 7 pm, without knowing that the grocery store closes at 6 pm. When the phone reminds the user at 7 pm to purchase milk, the store is already closed, thereby reducing, if not eliminating, the usefulness of the reminder.

Some of these phones also include a digital assistant, like Applicant's SIRI. Just like human assistants, digital assistants or virtual assistants can perform requested tasks and provide requested advice, information, or services. An assistant's ability to fulfill a user's request is dependent on the assistant's correct comprehension of the request or instructions. Recent advances in natural language processing have enabled users to interact with digital assistants using natural language, in spoken or textual forms, rather than employing a conventional user interface (e.g., menus or programmed commands).

Current smart-phones, however, do not make full use of the intelligence of the digital assistants to enhance the usefulness of time-based reminders. As such, it would be desirable to improve the usefulness of time-based reminders by having the digital assistant be cognizant of its surroundings and the content of a reminder.

### SUMMARY

According to some embodiments, there is provided a computer-implemented method for providing information relating to reminders. The method is performed at an electronic device comprising a processor and memory storing instructions for execution by the processor. In some embodiments the electronic device is a server that communicates with multiple client devices.

In some embodiments, prior to receiving the text string, a speech input is received from a user, and converted to a text string. Next, the text string is received by the device. The text string corresponds to a natural language speech input received from a user. The text string is processed, using natural language processing, to determine that the text string includes a command to create a reminder item to remind the user at a certain time to perform a certain activity. In some embodiments, at least one service is identified that contains information that may affect performance of the certain activity at the certain time. At least one service then searched to locate information that may affect performance of the certain activity at the certain time.

In some embodiments, the searching is performed at or near the time of receipt of the text string. In other embodiments, the searching is performed at or near the certain time. In yet other embodiments, the searching is performed at or near the time of receipt of the text string and at or near the certain time. In still other embodiments, the searching is performed periodically. In some embodiments, at least two services are searched, each service containing information of a different type.

In some embodiments, the time includes a time of the day and a date. If the text string does not include a date, the system assumes that the date of the reminder is the day that the text string is received. In some embodiments, the date is inferred from other words in the text string. In some embodiments, the text string also comprises a certain location. Here, the at least one service comprises a navigation service to determine how long it will take the user to travel from a current location of the user to the certain location.

If no information that will affect performance of the certain activity at the certain time is located, a reminder to remind the user at the certain time to perform the certain activity is created.

If information that may affect performance of the certain activity at the certain time is located, a notification is generated that performance of the certain activity at the certain time may be affected. The notification that performance of the certain activity at the certain time may be affected is either transmitted or displayed to the user. The notification may provide at least one alternative reminder item to the user, where the at least one alternative reminder item changes at least one of a time, activity, date, location of the reminder item. Alternatively, the notification may automatically (without human intervention) change the reminder based on the information located.

According to the invention there is also provided an electronic device having one or more processors, memory, and one or more programs. The one or more programs are stored in the memory and configured to be executed by the one or more processors, the one or more programs include instructions for performing the methods described herein.

According to the invention there is also provided non-transitory computer readable storage media for providing voice feedback to a user of an electronic device. The computer readable media comprises computer program logic recorded thereon for performing the methods described herein.

The systems and methods described herein allow a digital assistant to be cognizant of the content (e.g., activity and time) of a reminder as well as information available from various services (e.g., store hours). This ability greatly improves the usability, client experience, and overall usefulness of time-based reminders.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an environment in which a digital assistant operates in accordance with some implementations.

FIG. 2 is a block diagram illustrating a digital assistant client system in accordance with some implementations.

FIG. 3A is a block diagram illustrating a digital assistant system or a server portion thereof in accordance with some implementations.

FIG. 3B is a block diagram illustrating functions of the digital assistant shown in FIG. 3A in accordance with some implementations.

FIG. 3C is a diagram of a portion of an ontology in accordance with some implementations.

FIG. 4 is a flow-chart of a method for making time-based reminders more cognizant of the content of the reminder and the surrounding context.

Like reference numerals refer to corresponding parts throughout the drawings.

### DESCRIPTION OF IMPLEMENTATIONS

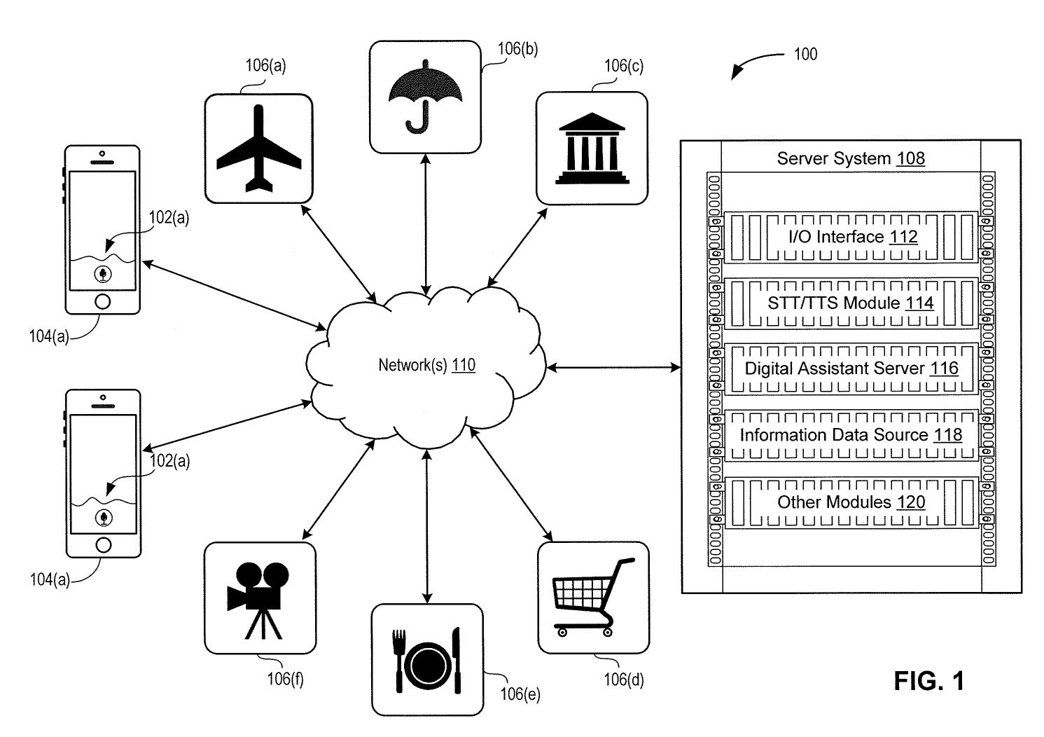

FIG. 1 is a block diagram of an operating environment 100 of a digital assistant according to some implementations. The terms “digital assistant,” “virtual assistant,” “intelligent automated assistant,” or “automatic digital assistant,” refer to any information processing system that interprets natural language input in spoken and/or textual form to infer user intent, and performs actions based on the inferred user intent. For example, to act on a inferred user intent, the system can perform one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g. speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request is either provision of the requested informational answer, performance of the requested task, or a combination of the two. For example, a user may ask the digital assistant a question, such as “Where am I right now?” Based on the user's current location, the digital assistant may answer, “You are in Central Park near the west gate.” The user may also request the performance of a task, for example, “Please remind me to buy milk at 7 pm.” In response, the digital assistant may acknowledge the request by saying “I have entered the following reminder—buy milk at 7 pm,” and then remind the user to buy milk when the it is 7 pm. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

An example of a digital assistant is described in Applicant's U.S. Utility application Ser. No. 12/987,982 for “Intelligent Automated Assistant,” filed Jan. 10, 2011, the entire disclosure of which is incorporated herein by reference.

As shown in FIG. 1, in some implementations, a digital assistant is implemented according to a client-server model. The digital assistant includes a client-side portion 102a, 102b (hereafter “DA client 102”) executed on a user device 104a, 104b, and a server-side portion executed on a server system 108. The DA client 102 communicates with the DA server 116 through one or more networks 110. The DA client 102 provides client-side functionalities such as user-facing input and output processing and communications with the DA server 116. The DA server 116 provides server-side functionalities for any number of DA clients 102 each residing on a respective user device 104.

In some implementations, the server system 108 includes an I/O interface 112, a speech-to-text and/or text-to-speech (STT/TTS) module 114, the DA server 116, an information data source module 118, and a number of other modules 120. The I/O interface 112 facilitates input and output processing for the DA server 116. The STT/TTS module 114 assists with recognizing audible speech inputs into text and/or converting text into audible speech. In some embodiments, the conversion of text into speech is performed on the device 104 itself. The DA server 116 utilize data and models to determine the user's intent based on natural language input and perform task execution based on the inferred user intent. In some implementations, the DA server 116 also communicates with external services 106 through the network(s) 110 for task completion or information acquisition. The I/O interface 112 facilitates such communications.

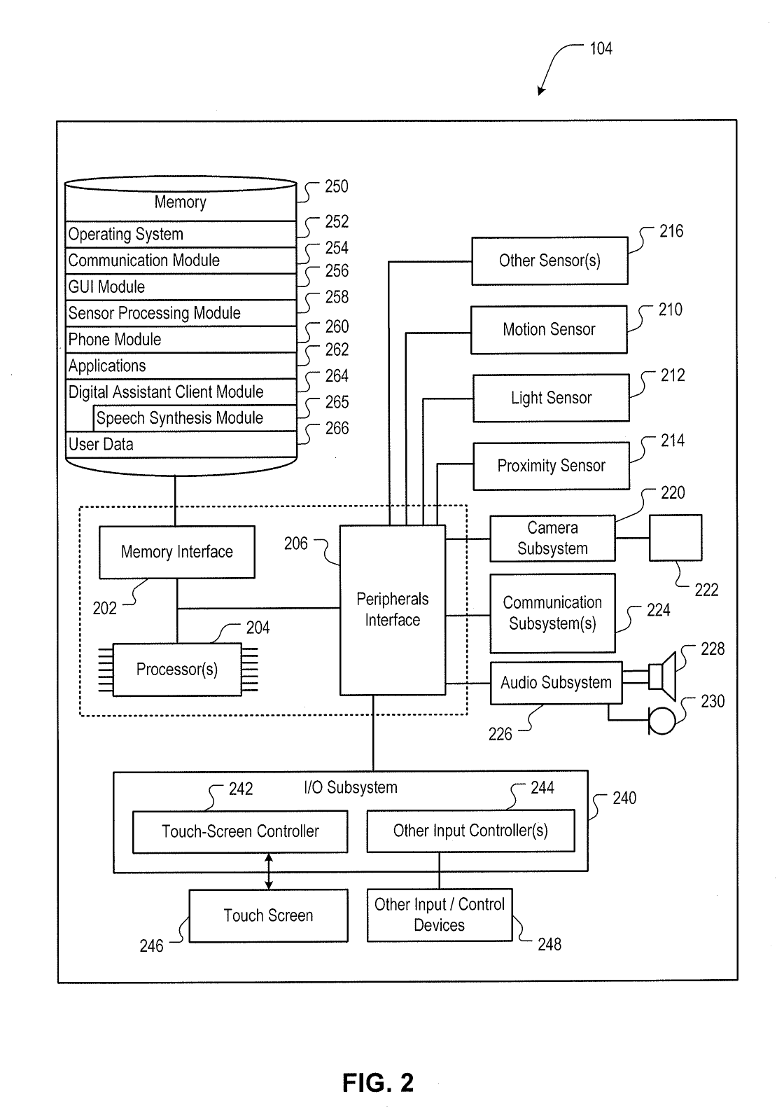

Examples of the user device 104 include, but are not limited to, a handheld computer, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices. More details on the user device 104 are provided in reference to an exemplary user device 104 shown in FIG. 2.

Examples of the communication network(s) 110 include local area networks (“LAN”) and wide area networks (“WAN”), e.g., the Internet. The communication network(s) 110 may be implemented using any known network protocol, including various wired or wireless protocols, such as e.g., Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

The server system 108 is implemented on one or more standalone data processing apparatus or a distributed network of computers. In some implementations, the server system 108 also employs various virtual devices and/or services of third party service providers (e.g., third-party cloud service providers) to provide the underlying computing resources and/or infrastructure resources of the server system 108.

Although the digital assistant shown in FIG. 1 includes both a client-side portion (e.g., the DA-client 102) and a server-side portion (e.g., the DA-server 116), in some implementations, the functions of a digital assistant is implemented as a standalone application installed on a user device. In addition, the divisions of functionalities between the client and server portions of the digital assistant can vary in different implementations. For example, in some implementations, the DA client is a thin-client that provides only user-facing input and output processing functions, and delegates all other functionalities of the digital assistant to a backend server.

The external services 106 include any suitable service accessible by the DA server 116, such as a travel service 106(a), weather service 106(b), government service 106(c), retailer service 106(d), restaurant service 106(e), movie service 106(f), event service (not shown), sport score service (not shown), TV guide service (not shown), a stock exchange service (not shown), or the like. In some embodiments, each of these services provide a source of data. For example, the travel service 106(a) provides flight times and delays, the weather service 106(b) provides a local weather forecast, the government service 106(c) provides a list of dates of government holidays, the retailer service 106(d) provides the operating hours of nearby stores, the restaurant service 106(e) provides the operating hours of nearby restaurants, the movie service 106(f) provides the start times and duration of movies currently showing at nearby theaters, the event service provides the start times and duration of nearby events, the sport score service provides sports scores, the TV guide service provides the start time and duration of TV shows, and the stock exchange service provides current stock prices, etc. Other suitable services include the user's or another user's calendar, the user or other user's location, or another user's current activity (e.g., other user is in do-not-disturb mode, or is in another time-zone, not moving, and it is late a night in that time-zone—all indications that the user is sleeping). Typically, each of these services is accessed via a public API.

FIG. 2 is a block diagram of a user-device 104 in accordance with some implementations. The user device 104 includes a memory interface 202, one or more processors 204, and a peripherals interface 206. The various components in the user device 104 are coupled by one or more communication buses or signal lines. The user device 104 includes various sensors, subsystems, and peripheral devices that are coupled to the peripherals interface 206. The sensors, subsystems, and peripheral devices gather information and/or facilitate various functionalities of the user device 104.

For example, a motion sensor 210, a light sensor 212, and a proximity sensor 214 are coupled to the peripherals interface 206 to facilitate orientation, light, and proximity sensing functions. One or more other sensors 216, such as a positioning system (e.g., GPS receiver), a temperature sensor, a biometric sensor, a gyro, a compass, an accelerometer, and the like, are also connected to the peripherals interface 206, to facilitate related functionalities.

In some implementations, a camera subsystem 220 and an optical sensor 222 are utilized to facilitate camera functions, such as taking photographs and recording video clips. Communication functions are facilitated through one or more wired and/or wireless communication subsystems 224, which can include various communication ports, radio frequency receivers and transmitters, and/or optical (e.g., infrared) receivers and transmitters. An audio subsystem 226 is coupled to speakers 228 and a microphone 230 to facilitate voice-enabled functions, such as voice recognition, voice replication, digital recording, and telephony functions.

In some implementations, an I/O subsystem 240 is also coupled to the peripheral interface 206. The I/O subsystem 240 includes a touch-screen controller 242 and/or other input controller(s) 244. The touch-screen controller 242 is coupled to a touch-screen 246. The touch-screen 246 and the touch-screen controller 242 can, for example, detect contact and movement or break thereof using any of a plurality of touch sensitivity technologies, such as capacitive, resistive, infrared, surface acoustic wave technologies, proximity sensor arrays, and the like. The other input controller(s) 244 can be coupled to other input/control devices 248, such as one or more buttons, rocker switches, thumb-wheel, infrared port, USB port, and/or a pointer device such as a stylus.

In some implementations, the memory interface 202 is coupled to memory 250. The memory 250 can include high-speed random access memory and/or non-volatile memory, such as one or more magnetic disk storage devices, one or more optical storage devices, and/or flash memory (e.g., NAND, NOR).

In some implementations, the memory 250 stores an operating system 252, a communications module 254, a user interface module 256, a sensor processing module 258, a phone module 260, and applications 262. The operating system 252 includes instructions for handling basic system services and for performing hardware dependent tasks. The communications module 254 facilitates communicating with one or more additional devices, one or more computers and/or one or more servers. The user interface module 256 facilitates graphic user interface processing and output processing using other output channels (e.g., speakers). The sensor processing module 258 facilitates sensor-related processing and functions. The phone module 260 facilitates phone-related processes and functions. The application module 262 facilitates various functionalities of user applications, such as electronic-messaging, web browsing, media processing, Navigation, imaging, reminders, a calendar, to-do list, and/or other processes and functions.

As described in this specification, the memory 250 also stores client-side digital assistant instructions (e.g., in a digital assistant client module 264) and various user data 266 (e.g., user-specific vocabulary data, preference data, and/or other data such as the user's electronic address book, to-do lists, shopping lists, user-specified name pronunciations, time-based reminder list with multiple reminder items and associated dates/times, etc.) to provide the client-side functionalities of the digital assistant.

In various implementations, the digital assistant client module 264 is capable of accepting voice input (e.g., speech input), text input, touch input, and/or gestural input through various user interfaces (e.g., the I/O subsystem 240) of the user device 104. The digital assistant client module 264 is also capable of providing output in audio (e.g., speech output), visual, and/or tactile forms. For example, output can be provided as voice, sound, alerts, text messages, menus, graphics, videos, animations, vibrations, and/or combinations of two or more of the above. During operation, the digital assistant client module 264 communicates with the digital assistant server using the communication subsystems 224.

In some implementations, the digital assistant client module 264 includes a speech synthesis module 265. The speech synthesis module 265 synthesizes speech outputs for presentation to the user. The speech synthesis module 265 synthesizes speech outputs based on text provided by the digital assistant. For example, the digital assistant generates text to provide as an output to a user, and the speech synthesis module 265 converts the text to an audible speech output. The speech synthesis module 265 uses any appropriate speech synthesis technique in order to generate speech outputs from text, including but not limited to concatenative synthesis, unit selection synthesis, diphone synthesis, domain-specific synthesis, formant synthesis, articulatory synthesis, hidden Markov model (HMM) based synthesis, and sinewave synthesis.

In some implementations, instead of (or in addition to) using the local speech synthesis module 265, speech synthesis is performed on a remote device (e.g., the server system 108), and the synthesized speech is sent to the user device 104 for output to the user. For example, this occurs in some implementations where outputs for a digital assistant are generated at a server system. And because server systems generally have more processing power or resources than a user device, it may be possible to obtain higher quality speech outputs than would be practical with client-side synthesis.

In some implementations, the digital assistant client module 264 utilizes the various sensors, subsystems and peripheral devices to gather additional information from the surrounding environment of the user device 104 to establish a context associated with a user, the current user interaction, and/or the current user input. In some implementations, the digital assistant client module 264 provides the context information or a subset thereof with the user input to the digital assistant server to help infer the user's intent. In some implementations, the digital assistant also uses the context information to determine how to prepare and delivery outputs to the user.

In some implementations, the context information that accompanies the user input includes sensor information, e.g., lighting, ambient noise, ambient temperature, images or videos of the surrounding environment, etc. In some implementations, the context information also includes the physical state of the device, e.g., device orientation, device location, device temperature, power level, speed, acceleration, motion patterns, cellular signals strength, etc. In some implementations, information related to the software state of the user device 104, e.g., running processes, installed programs, past and present network activities, background services, error logs, resources usage, etc., of the user device 104 are provided to the digital assistant server as context information associated with a user input.

In some implementations, the DA client module 264 selectively provides information (e.g., user data 266) stored on the user device 104 in response to requests from the digital assistant server. In some implementations, the digital assistant client module 264 also elicits additional input from the user via a natural language dialogue or other user interfaces upon request by the digital assistant server 106. The digital assistant client module 264 passes the additional input to the digital assistant server 106 to help the digital assistant server 106 in intent deduction and/or fulfillment of the user's intent expressed in the user request.

In various implementations, the memory 250 includes additional instructions or fewer instructions. Furthermore, various functions of the user device 104 may be implemented in hardware and/or in firmware, including in one or more signal processing and/or application specific integrated circuits.

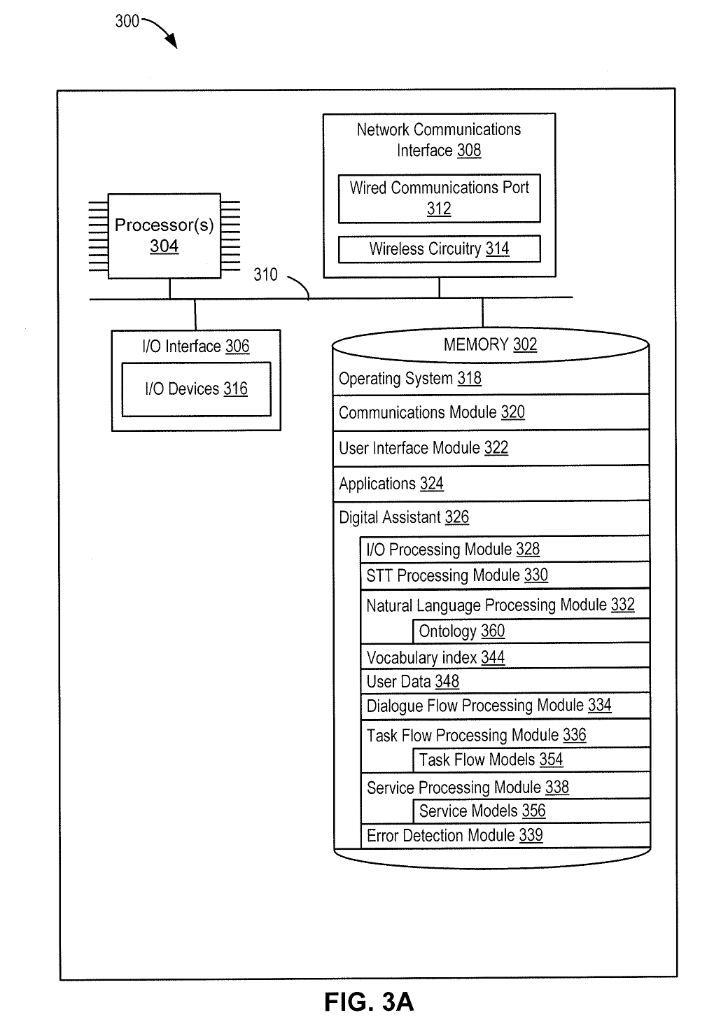

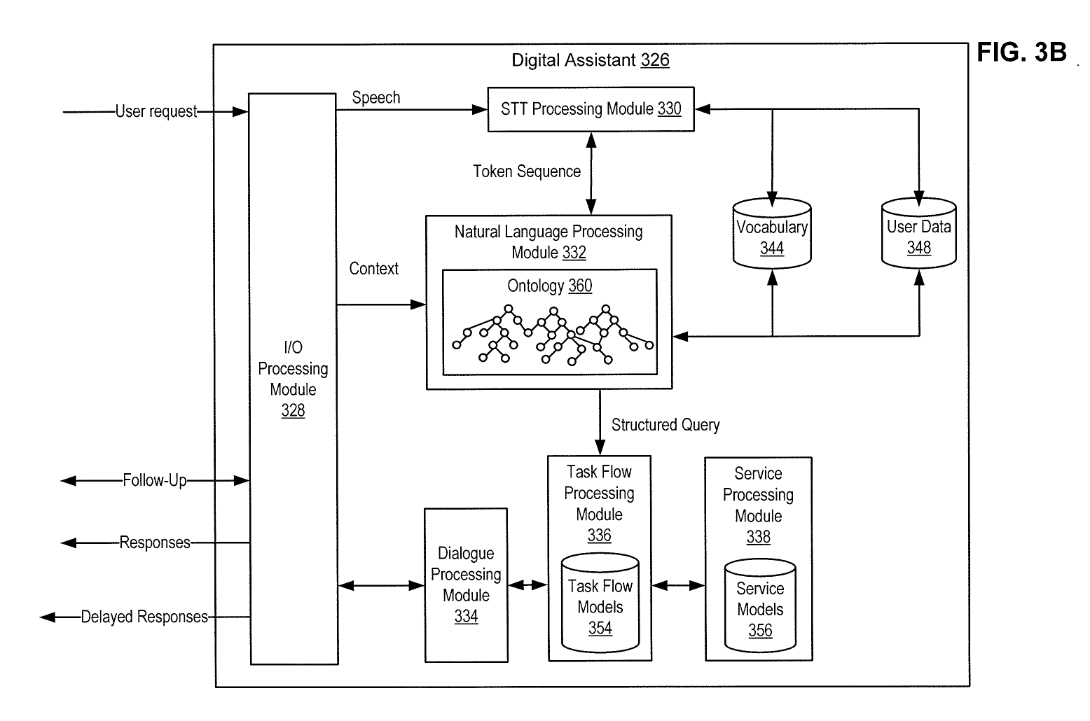

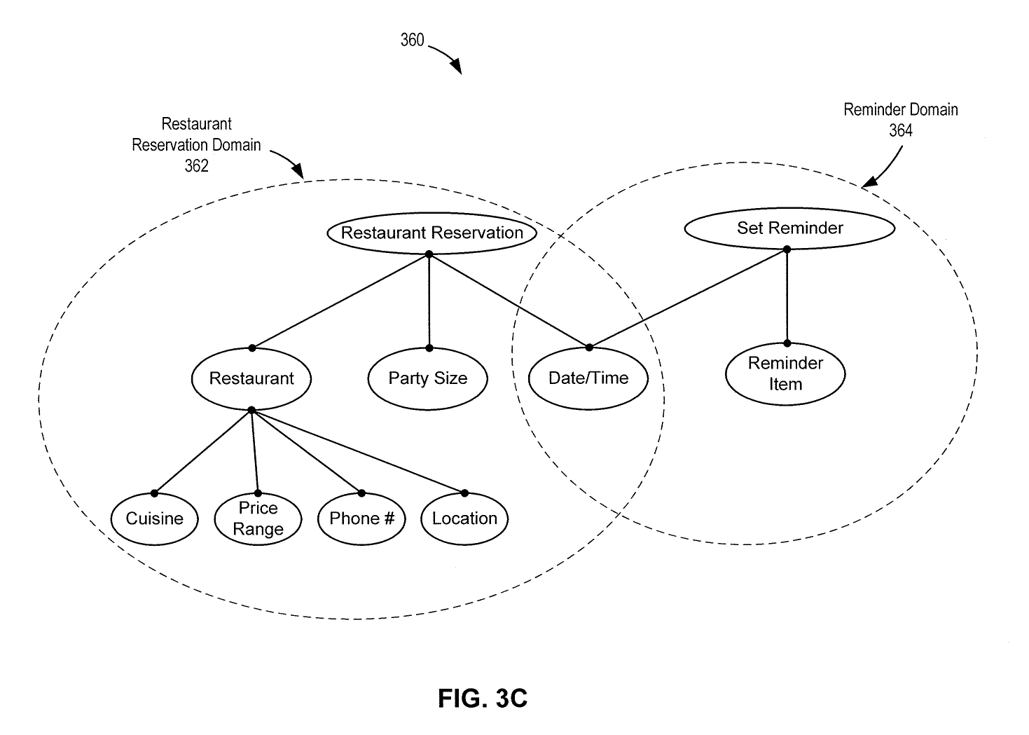

FIG. 3A is a block diagram of an example digital assistant server 116 in accordance with some implementations. In some implementations, the digital assistant server 116 is implemented on a standalone computer system. In some implementations, the digital assistant server 116 is distributed across multiple computers. In some implementations, some of the modules and functions of the digital assistant are divided into a server portion and a client portion, where the client portion resides on a user device (e.g., the user device 104) and communicates with the server portion (e.g., the server system 108) through one or more networks, e.g., as shown in FIG. 1. In some implementations, the digital assistant server 116 is an implementation of the server system 108 (and/or the digital assistant server 106) shown in FIG. 1. It should be noted that the digital assistant server 116 is only one example of a digital assistant system, and that the digital assistant server 116 may have more or fewer components than shown, may combine two or more components, or may have a different configuration or arrangement of the components. The various components shown in FIG. 3A may be implemented in hardware, software instructions for execution by one or more processors, firmware, including one or more signal processing and/or application specific integrated circuits, or a combination of thereof.

The digital assistant server 116 includes memory 302, one or more processors 304, an input/output (I/O) interface 306, and a network communications interface 308. These components communicate with one another over one or more communication buses or signal lines 310.

In some implementations, the memory 302 includes a non-transitory computer readable medium, such as high-speed random access memory and/or a non-volatile computer readable storage medium (e.g., one or more magnetic disk storage devices, flash memory devices, or other non-volatile solid-state memory devices).

In some implementations, the I/O interface 306 couples input/output devices 316 of the digital assistant server 116, such as displays, keyboards, touch-screens, and microphones, to the user interface module 322. The I/O interface 306, in conjunction with the user interface module 322, receives user inputs (e.g., voice input, keyboard inputs, touch inputs, etc.) and processes them accordingly. In some implementations, e.g., when the digital assistant is implemented on a standalone user device, the digital assistant server 116 includes any of the components and I/O and communication interfaces described with respect to the user device 104 in FIG. 2. In some implementations, the digital assistant server 116 represents the server portion of a digital assistant implementation, and interacts with the user through a client-side portion residing on a user device (e.g., the user device 104 shown in FIG. 2).

In some implementations, the network communications interface 308 includes wired communication port(s) 312 and/or wireless transmission and reception circuitry 314. The wired communication port(s) receive and send communication signals via one or more wired interfaces, e.g., Ethernet, Universal Serial Bus (USB), FIREWIRE, etc. The wireless circuitry 314 receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 308 enables communication between the digital assistant server 116 with networks, such as the Internet, an Intranet and/or a wireless network, such as a cellular telephone network, a wireless local area network (LAN) and/or a metropolitan area network (MAN), and other devices.

In some implementations, memory 302, or the computer readable storage media of memory 302, stores programs, modules, instructions, and data structures including all or a subset of: an operating system 318, a communications module 320, a user interface module 322, one or more applications 324, and a digital assistant module 326. The one or more processors 304 execute these programs, modules, and instructions, and reads/writes from/to the data structures.

The operating system 318 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

The communications module 320 facilitates communications between the digital assistant server 116 with other devices over the network communications interface 308. For example, the communications module 320 may communicate with the communications module 254 of the device 104 shown in FIG. 2. The communications module 320 also includes various components for handling data received by the wireless circuitry 314 and/or wired communications port 312.

The user interface module 322 receives commands and/or inputs from a user via the I/O interface 306 (e.g., from a keyboard, touch-screen, pointing device, controller, and/or microphone), and generates user interface objects on a display. The user interface module 322 also prepares and delivers outputs (e.g., speech, sound, animation, text, icons, vibrations, haptic feedback, and light, etc.) to the user via the I/O interface 306 (e.g., through displays, audio channels, speakers, and touch-pads, etc.).

The applications 324 include programs and/or modules that are configured to be executed by the one or more processors 304. For example, if the digital assistant system is implemented on a standalone user device, the applications 324 may include user applications, such as games, a calendar application, a navigation application, or an email application. If the digital assistant server 116 is implemented on a server farm, the applications 324 may include resource management applications, diagnostic applications, or scheduling applications, for example.

The memory 302 also stores the digital assistant module (or the server portion of a digital assistant) 326. In some implementations, the digital assistant module 326 includes the following sub-modules, or a subset or superset thereof: an input/output processing module 328, a speech-to-text (STT) processing module 330, a natural language processing module 332, a dialogue flow processing module 334, a task flow processing module 336, a service processing module 338, and a speech interaction error detection module 339. Each of these modules has access to one or more of the following data and models of the digital assistant module 326, or a subset or superset thereof: ontology 360, vocabulary index 344, user data 348, task flow models 354, and service models 356.

In some implementations, using the processing modules, data, and models implemented in the digital assistant module 326, the digital assistant performs at least some of the following: identifying a user's intent expressed in a natural language input received from the user; actively eliciting and obtaining information needed to fully infer the user's intent (e.g., by disambiguating words, names, intentions, etc.); determining the task flow for fulfilling the inferred intent; and executing the task flow to fulfill the inferred intent.

In some implementations, as shown in FIG. 3B, the I/O processing module 328 interacts with the user through the I/O devices 316 in FIG. 3A or with a user device (e.g., a user device 104 in FIG. 1) through the network communications interface 308 in FIG. 3A to obtain user input (e.g., a speech input) and to provide responses (e.g., as speech outputs) to the user input. The I/O processing module 328 optionally obtains context information associated with the user input from the user device, along with or shortly after the receipt of the user input. The context information includes user-specific data, vocabulary, and/or preferences relevant to the user input. In some implementations, the context information also includes software and hardware states of the device (e.g., the user device 104 in FIG. 1) at the time the user request is received, and/or information related to the surrounding environment of the user at the time that the user request was received. In some implementations, the I/O processing module 328 also sends follow-up questions to, and receives answers from, the user regarding the user request. When a user request is received by the I/O processing module 328 and the user request contains a speech input, the I/O processing module 328 forwards the speech input to the speech-to-text (STT) processing module 330 for speech-to-text conversions.

The speech-to-text processing module 330 (or speech recognizer) receives speech input (e.g., a user utterance captured in a voice recording) through the I/O processing module 328. In some implementations, the STT processing module 330 uses various acoustic and language models to recognize the speech input as a sequence of phonemes, and ultimately, a sequence of words or tokens written in one or more languages. The STT processing module 330 can be implemented using any suitable speech recognition techniques, acoustic models, and language models, such as Hidden Markov Models, Dynamic Time Warping (DTW)-based speech recognition, and other statistical and/or analytical techniques. In some implementations, the speech-to-text processing can be performed at least partially by a third party service or on the user's device. Once the STT processing module 330 obtains the result of the speech-to-text processing, e.g., a sequence of words or tokens, it passes the result to the natural language processing module 332 for intent deduction. In some implementations, the STT processing module 330 resides on a server computer (e.g., the server system 108), while in some implementations, it resides on a client device (e.g., the user device 104).

In some implementations, the STT processing module 330 provides more than one speech recognition result to the natural language processing module 332 for intent deduction. Specifically, the STT processing module 330 produces a set of candidate text strings, each representing a possible transcription of a speech input. In some implementations, each of the candidate text strings is associated with a speech recognition confidence score representing a confidence that the candidate text string is a correct transcription of the speech input.

In some implementations, the set of candidate text strings represents a portion of the text strings that the STT processing module 330 generates for a given speech input. For example, in some implementations, the set of candidate text strings includes text strings that have a speech recognition confidence score above a predetermined threshold. In some implementations, the set of candidate text strings includes the n-best text strings. (E.g., the 2, 5, 10, or 15 best text strings (or any other appropriate number), based on speech recognition confidence scores.)

When an utterance is received, the STT processing module 330 attempts to identify the phonemes in the utterance (e.g., using an acoustic model), and then attempts to identify words that match the phonemes (e.g., using a language model). For example, if the STT processing module 330 first identifies the sequence of phonemes “tuh-may-doe” in an utterance, it then determines, based on the vocabulary index 344, that this sequence corresponds to the word “tomato.”

In some implementations, the STT processing module 330 uses approximate matching techniques to determine words in an utterance. Thus, for example, the STT processing module 330 can determine that the sequence of phonemes “duh-may-doe” corresponds to the word “tomato,” even if that particular sequence of phonemes is not one of the candidate pronunciations for that word.

The natural language processing module 332 (“natural language processor”) of the digital assistant takes the text string or text strings generated by the speech-to-text processing module 330 (also referred to as a sequence of words or tokens, or “token sequence”), and attempts to determine a domain of the token sequence and/or associate the token sequence with one or more “actionable intents” recognized by the digital assistant. An “actionable intent” represents a task that can be performed by the digital assistant, and has an associated task flow implemented in the task flow models 354. The associated task flow is a series of programmed actions and steps that the digital assistant takes in order to perform the task. The scope of a digital assistant's capabilities is dependent on the number and variety of task flows that have been implemented and stored in the task flow models 354, or in other words, on the number and variety of “actionable intents” that the digital assistant recognizes. The effectiveness of the digital assistant, however, is also dependent on the assistant's ability to infer the correct “actionable intent(s)” from the user request expressed in natural language.

In some implementations, in addition to the sequence of words or tokens obtained from the speech-to-text processing module 330, the natural language processing module 332 also receives context information associated with the user request, e.g., from the I/O processing module 328. The natural language processing module 332 optionally uses the context information to clarify, supplement, and/or further define the information contained in the token sequence received from the speech-to-text processing module 330. The context information includes, for example, user preferences, hardware and/or software states of the user device, sensor information collected before, during, or shortly after the user request, prior interactions (e.g., dialogue) between the digital assistant and the user, and the like. As described in this specification, context information is dynamic, and can change with time, location, content of the dialogue, and other factors.

In some implementations, the natural language processing is based on e.g., ontology 360. The ontology 360 is a hierarchical structure containing many nodes, each node representing either an “actionable intent” or a “property” relevant to one or more of the “actionable intents” or other “properties”. As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in the ontology 360 defines how a parameter represented by the property node pertains to the task represented by the actionable intent node.

In some implementations, the ontology 360 is made up of actionable intent nodes and property nodes. Within the ontology 360, each actionable intent node is linked to one or more property nodes either directly or through one or more intermediate property nodes. Similarly, each property node is linked to one or more actionable intent nodes either directly or through one or more intermediate property nodes. For example, as shown in FIG. 3C, the ontology 360 may include a “restaurant reservation” node (i.e., an actionable intent node). Property nodes “restaurant,” “date/time” (for the reservation), and “party size” are each directly linked to the actionable intent node (i.e., the “restaurant reservation” node). In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 3C, the ontology 360 may also include a “set reminder” node (i.e., another actionable intent node). Property nodes “date/time” (for the setting the reminder) and “reminder item” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in the ontology 360.

An actionable intent node, along with its linked concept nodes, may be described as a “domain.” In the present discussion, each domain is associated with a respective actionable intent, and refers to the group of nodes (and the relationships therebetween) associated with the particular actionable intent. For example, the ontology 360 shown in FIG. 3C includes an example of a restaurant reservation domain 362 and an example of a reminder domain 364 within the ontology 360. The restaurant reservation domain includes the actionable intent node “restaurant reservation,” property nodes “restaurant,” “date/time,” and “party size,” and sub-property nodes “cuisine,” “price range,” “phone number,” and “location.” The reminder domain 364 includes the actionable intent node “set reminder,” and property nodes “reminder item” and associated “date/time.” In some implementations, the ontology 360 is made up of many domains. Each domain may share one or more property nodes with one or more other domains. For example, the “date/time” property node may be associated with many different domains (e.g., a scheduling domain, a travel reservation domain, a movie ticket domain, etc.), in addition to the restaurant reservation domain 362 and the reminder domain 364.

While FIG. 3C illustrates two example domains within the ontology 360, other domains (or actionable intents) include, for example, “initiate a phone call,” “find directions,” “schedule a meeting,” “send a message,” and “provide an answer to a question,” “read a list”, “providing navigation instructions,” “provide instructions for a task” and so on. A “send a message” domain is associated with a “send a message” actionable intent node, and may further include property nodes such as “recipient(s)”, “message type”, and “message body.” The property node “recipient” may be further defined, for example, by the sub-property nodes such as “recipient name” and “message address.”

In some implementations, the ontology 360 includes all the domains (and hence actionable intents) that the digital assistant is capable of understanding and acting upon. In some implementations, the ontology 360 may be modified, such as by adding or removing entire domains or nodes, or by modifying relationships between the nodes within the ontology 360.

In some implementations, nodes associated with multiple related actionable intents may be clustered under a “super domain” in the ontology 360. For example, a “travel” super-domain may include a cluster of property nodes and actionable intent nodes related to travels. The actionable intent nodes related to travels may include “airline reservation,” “hotel reservation,” “car rental,” “get directions,” “find points of interest,” and so on. The actionable intent nodes under the same super domain (e.g., the “travels” super domain) may have many property nodes in common. For example, the actionable intent nodes for “airline reservation,” “hotel reservation,” “car rental,” “get directions,” “find points of interest” may share one or more of the property nodes “start location,” “destination,” “departure date/time,” “arrival date/time,” and “party size.”

In some implementations, each node in the ontology 360 is associated with a set of words and/or phrases that are relevant to the property or actionable intent represented by the node. The respective set of words and/or phrases associated with each node is the so-called “vocabulary” associated with the node. The respective set of words and/or phrases associated with each node can be stored in the vocabulary index 344 in association with the property or actionable intent represented by the node. For example, returning to FIG. 3B, the vocabulary associated with the node for the property of “restaurant” may include words such as “food,” “drinks,” “cuisine,” “hungry,” “eat,” “pizza,” “fast food,” “meal,” and so on. For another example, the vocabulary associated with the node for the actionable intent of “initiate a phone call” may include words and phrases such as “call,” “phone,” “dial,” “ring,” “call this number,” “make a call to,” and so on. The vocabulary index 344 optionally includes words and phrases in different languages.

The natural language processing module 332 receives the token sequence (e.g., a text string) from the speech-to-text processing module 330, and determines what nodes are implicated by the words in the token sequence. In some implementations, if a word or phrase in the token sequence is found to be associated with one or more nodes in the ontology 360 (via the vocabulary index 344), the word or phrase will “trigger” or “activate” those nodes. Based on the quantity and/or relative importance of the activated nodes, the natural language processing module 332 will select one of the actionable intents as the task that the user intended the digital assistant to perform. In some implementations, the domain that has the most “triggered” nodes is selected. In some implementations, the domain having the highest confidence score (e.g., based on the relative importance of its various triggered nodes) is selected. In some implementations, the domain is selected based on a combination of the number and the importance of the triggered nodes. In some implementations, additional factors are considered in selecting the node as well, such as whether the digital assistant has previously correctly interpreted a similar request from a user.

In some implementations, the natural language processing module 332 determines a domain for a particular token sequence, but cannot initially determine (either at all or to a sufficient degree of confidence) a particular actionable intent for the token sequence. In some implementations, as described herein, the natural language processing module 332 processes the token sequence again, for example, by relaxing its search and/or word-matching criteria, and/or by limiting its search to a particular domain or word list. Specifically, in some implementations, the natural language processing module 332 relaxes a word-matching criteria relative to the initial processing (e.g., approximate string matching rather than exact string matching; phonetic matching instead of string matching, etc.). In some implementations, the natural language processing module 332 limits its subsequent processing of the token sequence to a particular list of words, such as a list of named entities that are associated with the identified domain (e.g., a list of known movie titles if the domain is a “movie” domain, a list of known restaurant names if the domain is a “restaurant reservation” domain, etc.)

In some implementations, the natural language processing module 332 receives multiple token sequences (e.g., text strings) from the STT processing module 330, and processes them to determine a domain and/or an actionable intent for each token sequence (or at least a subset of the token sequences from the STT processing module 330). In some implementations, each domain and/or actionable intent is associated with an intent deduction confidence score representing a confidence that the determined domain and/or actionable intent correctly reflects the intent represented by the token sequence.

In some implementations, the digital assistant also stores names of specific entities in the vocabulary index 344, so that when one of these names is detected in the user request, the natural language processing module 332 will be able to recognize that the name refers to a specific instance of a property or sub-property in the ontology. In some implementations, the names of specific entities are names of businesses, restaurants, people, movies, and the like. In some implementations, the digital assistant searches and identifies specific entity names from other data sources, such as the user's address book, a movies database, a musicians database, and/or a restaurant database. In some implementations, when the natural language processing module 332 identifies that a word in the token sequence is a name of a specific entity (such as a name in the user's address book), that word is given additional significance in selecting the actionable intent within the ontology for the user request.

For example, when the words “Mr. Santo” are recognized from the user request, and the last name “Santo” is found in the vocabulary index 344 as one of the contacts in the user's contact list, then it is likely that the user request corresponds to a “send a message” or “initiate a phone call” domain. For another example, when the words “ABC Café” are found in the user request, and the term “ABC Café” is found in the vocabulary index 344 as the name of a particular restaurant in the user's city, then it is likely that the user request corresponds to a “restaurant reservation” domain.

User data 348 includes user-specific information, such as user-specific vocabulary, user preferences, user address, user's default and secondary languages, user's contact list, and other short-term or long-term information for each user. In some implementations, the natural language processing module 332 uses the user-specific information to supplement the information contained in the user input to further define the user intent. For example, for a user request “invite my friends to my birthday party,” the natural language processing module 332 is able to access user data 348 to determine who the “friends” are and when and where the “birthday party” would be held, rather than requiring the user to provide such information explicitly in his/her request.

Other details of searching an ontology based on a token string is described in U.S. Utility application Ser. No. 12/341,743 for “Method and Apparatus for Searching Using An Active Ontology,” filed Dec. 22, 2008, the entire disclosure of which is incorporated herein by reference.

In some implementations, once the natural language processing module 332 identifies an actionable intent (or domain) based on the user request, the natural language processing module 332 generates a structured query to represent the identified actionable intent. In some implementations, the structured query includes parameters for one or more nodes within the domain for the actionable intent, and at least some of the parameters are populated with the specific information and requirements specified in the user request. For example, the user may say “Make me a dinner reservation at a sushi place at 7.” In this case, the natural language processing module 332 may be able to correctly identify the actionable intent to be “restaurant reservation” based on the user input. According to the ontology, a structured query for a “restaurant reservation” domain may include parameters such as {Cuisine}, {Time}, {Date}, {Party Size}, and the like. In some implementations, based on the information contained in the user's utterance, the natural language processing module 332 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some implementations, the natural language processing module 332 populates some parameters of the structured query with received context information. For example, in some implementations, if the user requested a sushi restaurant “near me,” the natural language processing module 332 populates a {location} parameter in the structured query with GPS coordinates from the user device 104.

In some implementations, the natural language processing module 332 passes the structured query (including any completed parameters) to the task flow processing module 336 (“task flow processor”). The task flow processing module 336 is configured to receive the structured query from the natural language processing module 332, complete the structured query, if necessary, and perform the actions required to “complete” the user's ultimate request. In some implementations, the various procedures necessary to complete these tasks are provided in task flow models 354. In some implementations, the task flow models include procedures for obtaining additional information from the user, and task flows for performing actions associated with the actionable intent.

As described above, in order to complete a structured query, the task flow processing module 336 may need to initiate additional dialogue with the user in order to obtain additional information, and/or disambiguate potentially ambiguous utterances. When such interactions are necessary, the task flow processing module 336 invokes the dialogue processing module 334 (“dialogue flow processing module 334”) to engage in a dialogue with the user. In some implementations, the dialogue flow processing module 334 determines how (and/or when) to ask the user for the additional information, and receives and processes the user responses. The questions are provided to and answers are received from the users through the I/O processing module 328. In some implementations, the dialogue flow processing module 334 presents dialogue output to the user via audio and/or visual output, and receives input from the user via spoken or physical (e.g., clicking) responses. Continuing with the example above, when the task flow processing module 336 invokes the dialogue flow processing module 334 to determine the “party size” and “date” information for the structured query associated with the domain “restaurant reservation,” the dialogue flow processing module 334 generates questions such as “For how many people?” and “On which day?” to pass to the user. Once answers are received from the user, the dialogue flow processing module 334 can then populate the structured query with the missing information, or pass the information to the task flow processing module 336 to complete the missing information from the structured query.

In some cases, the task flow processing module 336 may receive a structured query that has one or more ambiguous properties. For example, a structured query for the “send a message” domain may indicate that the intended recipient is “Bob,” and the user may have multiple contacts named “Bob.” The task flow processing module 336 will request that the dialogue flow processing module 334 disambiguate this property of the structured query. In turn, the dialogue flow processing module 334 may ask the user “Which Bob?”, and display (or read) a list of contacts named “Bob” from which the user may choose.

Once the task flow processing module 336 has completed the structured query for an actionable intent, the task flow processing module 336 proceeds to perform the ultimate task associated with the actionable intent. Accordingly, the task flow processing module 336 executes the steps and instructions in the task flow model according to the specific parameters contained in the structured query. For example, the task flow model for the actionable intent of “restaurant reservation” may include steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, the task flow processing module 336 may perform the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some implementations, the task flow processing module 336 employs the assistance of a service processing module 338 (“service processor”) to complete a task requested in the user input or to provide an informational answer requested in the user input. For example, the service processing module 338 can act on behalf of the task flow processing module 336 to make a phone call, set a calendar entry, invoke a map search, invoke or interact with other user applications installed on the user device, and invoke or interact with third party services (e.g. a restaurant reservation portal, a social networking website, a banking portal, etc.). In some implementations, the protocols and application programming interfaces (API) required by each service can be specified by a respective service model among the service models 356. The service processing module 338 accesses the appropriate service model for a service and generates requests for the service in accordance with the protocols and APIs required by the service according to the service model.

For example, if a restaurant has enabled an online reservation service, the restaurant can submit a service model specifying the necessary parameters for making a reservation and the APIs for communicating the values of the necessary parameter to the online reservation service. When requested by the task flow processing module 336, the service processing module 338 can establish a network connection with the online reservation service using the web address stored in the service model, and send the necessary parameters of the reservation (e.g., time, date, party size) to the online reservation interface in a format according to the API of the online reservation service.

In some implementations, the natural language processing module 332, dialogue flow processing module 334, and task flow processing module 336 are used collectively and iteratively to infer and define the user's intent, obtain information to further clarify and refine the user intent, and finally generate a response (i.e., an output to the user, or the completion of a task) to fulfill the user's intent.

In some implementations, after all of the tasks needed to fulfill the user's request have been performed, the digital assistant module 326 formulates a confirmation response, and sends the response back to the user through the I/O processing module 328. If the user request seeks an informational answer, the confirmation response presents the requested information to the user. In some implementations, the digital assistant also requests the user to indicate whether the user is satisfied with the response produced by the digital assistant module 326.

The error detection module 339 detects errors in interactions between a user and the digital assistant. In some implementations, to detect errors, the error detection module 339 monitors interactions between a user and the digital assistant, and/or between a user and a user device. For example, the error detection module 339 monitors any of the following types of interactions, or a subset thereof: a user's speech inputs to the digital assistant (e.g., if a user says “you got that wrong” or “you are pronouncing that wrong”), button presses (e.g., if a user selects a lock-screen or “home” button (or any other affordance) to cancel an action), movements of the device (e.g., shaking the device, setting the device down in a certain orientation, such as screen-down), termination of actions or suggested actions on the user device (e.g., cancelling a telephone call, email, text message, etc. after the digital assistant initiates or suggests it), initiation of an action shortly after a digital assistant fails to successfully infer an intent or adequately respond to a user, etc. In some implementations, the error detection module 339 monitors other types of interactions to detect errors as well.

In order to detect such errors, in some implementations, the error detection module 339 communicates with or otherwise receives information from various modules and components of the digital assistant server 116 and/or the user device 104, such as the I/O processing module 328 (and/or the I/O devices 316), the STT processing module 330, natural language processing module 332, the dialogue flow processing module 334, the task flow processing module 336, the service processing module 338, the phone module 260, the sensor processing module 258, the I/O subsystem 240, and/or any of the sensors or I/O devices associated therewith.

More details on the digital assistant can be found in the U.S. Utility application Ser. No. 12/987,982, entitled “Intelligent Automated Assistant”, filed Jan. 10, 2011, U.S. Utility Application No. 61/493,201, entitled “Generating and Processing Data Items That Represent Tasks to Perform”, filed Jun. 3, 2011, the entire disclosures of which are incorporated herein by reference.

In most scenarios, when the digital assistant receives a user input from a user, the digital assistant attempts to provide an appropriate response to the user input with as little delay as possible. For example, suppose the user requests certain information (e.g., current traffic information) by providing a speech input (e.g., “How does the traffic look right now?”). Right after the digital assistant receives and processes the speech input, the digital assistant optionally provides a speech output (e.g., “Looking up traffic information . . . ”) acknowledging receipt of the user request. After the digital assistant obtains the requested information in response to the user request, the digital assistant proceeds to provide the requested information to the user without further delay. For example, in response to the user's traffic information request, the digital assistant may provide a series of one or more discrete speech outputs separated by brief pauses (e.g., “There are 2 accidents on the road. <Pause> One accident is on 101 north bound near Whipple Avenue. <Pause> And a second accident is on 85 north near 280.”), immediately after the speech outputs are generated.

For the purpose of this specification, the initial acknowledgement of the user request and the series of one or more discrete speech outputs provided in response to the user request are all considered sub-responses of a complete response to the user request. In other words, the digital assistant initiates an information provision process for the user request upon receipt of the user request, and during the information provision process, the digital assistant prepares and provides each sub-response of the complete response to the user request without requiring further prompts from the user.

Sometimes, additional information or clarification (e.g., route information) is required before the requested information can be obtained. In such scenarios, the digital assistant outputs a question (e.g., “Where are you going?”) to the user asking for the additional information or clarification. In some implementations, the question provided by the digital assistant is considered a complete response to the user request because the digital assistant will not take further actions or provide any additional response to the user request until a new input is received from the user. In some implementations, once the user provides the additional information or clarification, the digital assistant initiates a new information provision process for a “new” user request established based on the original user request and the additional user input.

In some implementations, the digital assistant initiates a new information provision process upon receipt of each new user input, and each existing information provision process terminates either (1) when all of the sub-responses of a complete response to the user request have been provided to the user or (2) when the digital assistant provides a request for additional information or clarification to the user regarding a previous user request that started the existing information provision process.

In general, after a user request for information or performance of a task is received by the digital assistant, it is desirable that the digital assistant provides a response (e.g., either an output containing the requested information, an acknowledgement of a requested task, or an output to request a clarification) as promptly as possible. Real-time responsiveness of the digital assistant is one of the key factors in evaluating performance of the digital assistant. In such cases, a response is prepared as quickly as possible, and a default delivery time for the response is a time immediately after the response is prepared.

Sometimes, however, after an initial sub-response provided immediately after receipt of the user input, the digital assistant provides the remaining one or more sub-responses one at a time over an extended period of time. In some implementations, the information provision process for a user request is stretched out over an extended period of time that is longer than the sum of the time required to provide each sub-response individually. For example, in some implementations, short pauses (i.e., brief periods of silence) are inserted between an adjacent pair of sub-responses (e.g., a pair of consecutive speech outputs) when they are delivered to the user through an audio-output channel.

In some implementations, a sub-response is held in abeyance after it is prepared and is delivered only when a predetermined condition has been met. In some implementations, the predetermined condition is met when a predetermined trigger time has been reached according to a system clock and/or when a predetermined trigger event has occurred. For example, if the user says to the digital assistant “set me a timer for 5 minutes,” the digital assistant initiates an information provision process upon receipt of the user request. During the information provision process, the digital assistant provides a first sub-response (e.g., “OK, timer started.”) right away, and does not provide a second and final sub-response (e.g., “OK, five minutes are up”) until 5 minutes later. In such cases, the default delivery time for the first sub-response is a time immediately after the first sub-response is prepared, and the default delivery time for the second, final sub-response is a time immediately after the occurrence of the trigger event (e.g., the elapse of 5 minutes from the start of the timer). The information provision process is terminated when the digital assistant finishes providing the final sub-response to the user. In various implementations, the second sub-response is prepared any time (e.g., right after the first sub-response is prepared, or until shortly before the default delivery time for the second sub-response) before the default delivery time for the second sub-response.

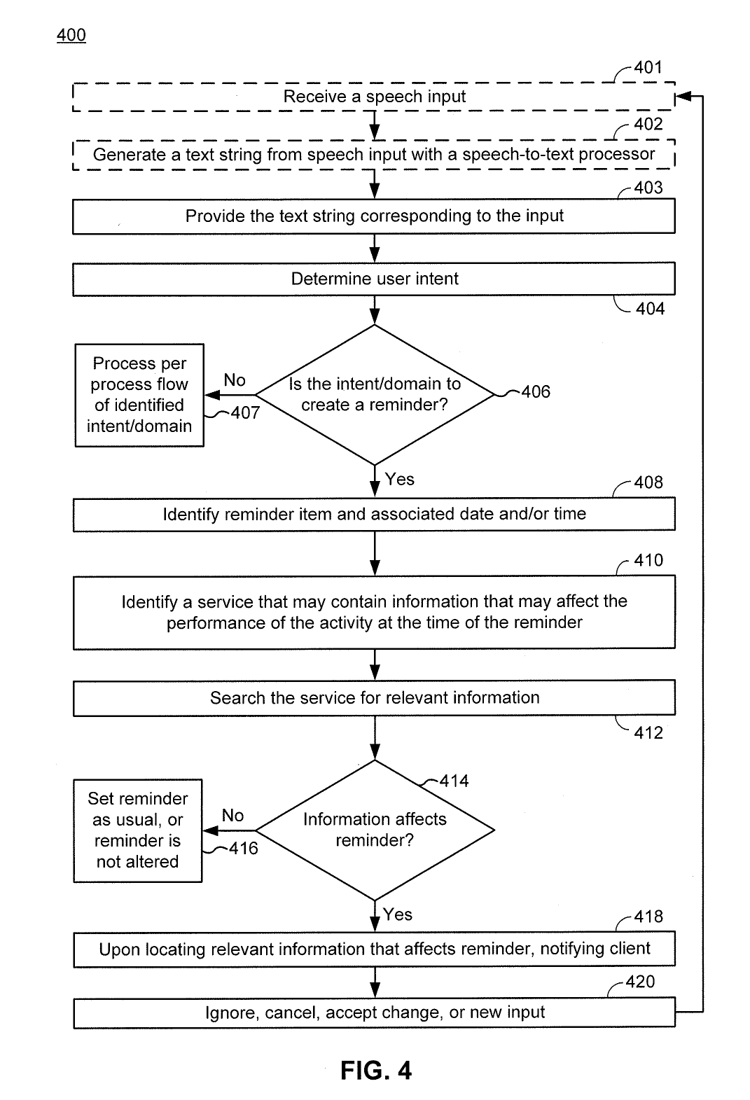

FIG. 4 is a flow chart of a method 600 for making time-based reminders more cognizant of the content of the reminder and the surrounding context. In some embodiments, a speech input is optionally received at 601. In these embodiments, the STT processing module 330 (FIG. 3A) generates a text string from the speech input at 602. In some embodiments, another service performs the speech recognition and sends the generated text string to the server system 108 (FIG. 1).

The digital assistant server 116 (FIGS. 1 and 3A) is provided with the text string at 603. In some embodiments, the digital assistant receives the text string that corresponds to a speech input, while in other embodiments, the text string is manually entered into the system by the user, i.e., not via speech input.

The digital assistant server 116 then determines the user's intent from the text string at 404. In some embodiments this involves determining a domain of the text string using natural language processing, as described above in relation to FIGS. 3A-C. If the intent or domain is not to create a reminder (406—No), then the input is processed per the process-flow for the identified intent or domain at 407. For example, if the identified intent or domain is to make a restaurant reservation, then the DA server 116 proceeds to make a restaurant reservation.

If, however, the identified intent or domain is to create a reminder (406—Yes), such as a time-based reminder, then the DA server 116 identifies a reminder item and associated date and/or time from the input (or text string) at 408. In some embodiments, the reminder includes at least a task or activity and a time, where the time can include a time of day, a date, and/or both a time of day and date. In some embodiments, the reminder also includes a location, e.g., the geographic location where the task or activity is scheduled or intended to occur.

If the text string does not include a date, the digital assistant assumes that the date of the reminder is the day that the text string is received. In some embodiments, the digital assistant looks at the other words in the text string to determine if a date can be determined from the text string. For example, the text string may be to “remind me early this year to buy a Christmas tree.” Here, the digital assistant will interpret “Christmas” to be December 25, and “early” to be a month before, and will therefore interpret the time and date to be, for example, 9 am on November 25.

The reminder item may be an activity or task, such as “pick up the laundry” or “call mom.” The associated date and/or time may be a specific future date and/or time, e.g., “7 pm tomorrow,” or it may be a general date and/or time, e.g., “before the end of the month” or “this summer.” In some embodiments, the reminder item does not include a date or time at all, and is merely a reminder that is viewed by the user when desired. In other embodiments, the reminder is not a time-based reminder at all, and, instead, is a location-based reminder, e.g., “remind me when I get home to tell my wife that I ran into her sister at the mall.”

Next, in some embodiments, at or near the time that the reminder is entered into the system, one or more services are identified that may contain information that may affect the performance of the activity contained in the reminder. For example, shortly after the system identifies the reminder item to “pick up milk at XYZ grocery store” at the associated date and/or time of 7 pm today (at 408), the DA server 116 determines that XYZ grocery store's website may contain operating hours that may affect the performance of the activity or task at 7 pm that day. In some embodiments, “near” means within a few minutes of the time that the reminder is received, while in other embodiments it means within a few hours. For example, if the reminder is far enough in the future, the DA server 116 may not identify relevant services until it has a WIFI connection or the like.

In other embodiments, or at or near the time that the reminder is presented to the user, one or more services are identified that may contain information that may affect the performance of the activity contained in the reminder. For example, 15 minutes before the reminder is to be presented to the user, the DA server 116 determines that XYZ grocery store's website may contain operating hours that may affect the performance of the activity or task at 7 pm that day. In some embodiments, “near” means within a few minutes before the time that the reminder is to be presented to the user, while in other embodiments it means within a few hours or days. For example, if the reminder requires a task to be performed at a specific location, the DA server may calculate the time that it will take the user to travel from the device's current location to the location where the activity is to be performed and identify the service in advance of the time that the user would need to leave the current location to arrive on time at the specific location.

To identify the one or more services that may contain information that may affect the performance of the activity, the DA server 116 first correlates the reminder item or activity or task with one or more services. For example, if the user needs to perform the activity at a store, then the DA server 116 identifies the corresponding store's website as service that that may contain information that may affect the performance of the activity. Other examples include:
identifying a service (106(b)) that provides weather forecasts that that may affect the performance of the activity, e.g., the user may not be able to play golf if it is raining;
identifying a service (106(a)) that provides flight delays that that may affect the performance of the activity, e.g., the user may not be able to pick-up his mother from the airport if her flight is delayed;
identifying a service (106(c)) that contains a listing of public holidays that that may affect the performance of the activity, e.g., the local government office may be closed on a public holiday;
identifying a service (106(d)) that contains a listing of store hours that that may affect the performance of the activity, e.g., XYZ grocery store may be closed;
identifying a service (106(e)) that contains a listing of restaurant operating hours that that may affect the performance of the activity, e.g., ABC restaurant may be temporarily closed for renovations; or
identifying a service (106(f)) that contains a listing of movie or TV start times that that may affect the performance of the activity, e.g., ABC movie may not be playing at XYZ theater that night.

Once the service has been identified, the service is searched at 412 for relevant information that may affect the performance of the reminder item or activity or task at the reminder date and/or time. As was the case with the identification of the service at 412, the search may be performed at or near the time that the service is identified (410), or at or near the time that the reminder is to be presented to the user. In some embodiments, the search may be performed periodically (e.g., on a set or dynamic schedule), or when the device is connected to a source of power (e.g., an AC outlet) and/or is connected to a cellular network and/or connected to WIFI or the like.

In some embodiments, searching a service may include searching a public or private database that is remotely located, such as the services 106 (FIG. 1) or another user's device, e.g., another user's calendar, time-zone, do-not-disturb settings, electronic wallet, or the like. In other embodiments, the service may be local, such as the information data source module 118 (FIG. 1). In yet other embodiments, the service may be located on the user's device, such as the user's calendar, a user's time-zone, a user's do-not-disturb settings, electronic wallet, or the user's find-my-friend application.

In some embodiments, the service is accessed through an API. Also, it should be appreciated that in some embodiments, the search occurs in the background without the user being aware that it is being performed. Also in some embodiments, more than one service may be searched in parallel or serially.

If no information is located, or information is located that does not affect the reminder (414—No), then the reminder is set as usual (if the search is performed at the time of entering the reminder) or the reminder is not changed (if the search is performed later after the reminder has already been entered) at 416.

Upon locating relevant information that affects (or may affect) the performance of the reminder item, task, or activity (414—Yes), the reminder is either automatically (without user intervention) updated to take this information into account; the user is notified and given the option to accept or change the reminder; or the user is simply notified without being given the option to accept or change the reminder at 418. In some embodiments, the user is notified by sending a message to the client device for display. For example, if the user set a reminder to buy milk at 7 pm, but the store closes at 6 pm, the user may be notified that the store closes at 6 pm, and if they would like to set the reminder for 5:45 pm instead. In some embodiments, the notification is relayed to the user through the digital assistant's speech.

In some embodiments, where the reminder item, task, or the activity is to be performed at a remote location, the digital assistant server 116 may also calculate the expected travel time from the user's current location to the remote location (taking into account traffic conditions, etc.), allow some time for the task or activity to be performed, and then ask the user if they would like to set the reminder for a time that is earlier than the time that the action is to be performed (say 15 minutes before store closes) less the travel time to the destination (say 45 minutes), which in this example would be a reminder to leave at 5 pm to go to the XYZ store to buy milk, where the store closes at 6 pm.

In some embodiments, the user is notified at 418 by sending the notification to the client device for display and/or speech output to the user. The user may then ignore the information and any suggested changes to the reminder; accept one or more of the suggested changes to the reminder; or enter a new input through a voice command or typed text, which is received at 420.

In some embodiments, the information that affects (or may affect) the performance of the reminder item, task, or activity is real-time data, i.e., current information, like current traffic conditions. In other embodiments, the information that affects (or may affect) the performance of the reminder item, task, or activity is not updated in real-time, e.g., movie listings.

The above described systems and methods allow a digital assistant to be cognizant of the content (e.g., activity and time) of a reminder as well as information available from various services (e.g., store hours). This ability greatly improves the usability, client experience, and overall usefulness of time-based reminders.

It should be understood that the particular order in which the operations have been described above is merely exemplary and is not intended to indicate that the described order is the only order in which the operations could be performed. One of ordinary skill in the art would recognize various ways to reorder the operations described herein.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A non-transitory computer readable storage media for providing voice feedback to a user of an electronic device, the computer readable media comprising computer program logic recorded thereon for:
receiving a text string corresponding to a natural language speech input received from a user;
processing the text string, using natural language processing, to determine that the text string includes a command to create a reminder item to remind the user at a certain time to perform a certain activity;
searching at least one service to locate information that may affect performance of the certain activity at the certain time; and
upon locating information that may affect performance of the certain activity at the certain time, generating a notification that performance of the certain activity at the certain time may be affected.

2. The storage media of claim 1, wherein the searching is performed at or near the time of receipt of the text string.

3. The storage media of claim 1, wherein the searching is performed at or near the certain time.

4. The storage media of claim 1, wherein the searching is performed at or near the time of receipt of the text string and at or near the certain time.

5. The storage media of claim 1, wherein the searching is performed periodically.

6. The storage media of claim 1, wherein the storage media further comprises computer program logic recorded thereon for:
prior to receiving the text string:
receiving a speech input from a user; and
generating the text string from the speech input.

7. The storage media of claim 1, wherein the storage media further comprises computer program logic recorded thereon for:
prior to searching the at least one service, identifying that the at least one service contains information that may affect performance of the certain activity at the certain time.

8. The storage media of claim 1, wherein the time includes a time of the day and a date.

9. The storage media of claim 1, wherein the storage media further comprises computer program logic recorded thereon for:
if the text string does not include a date, assuming that the date of the reminder is the day that the text string is received.

10. The storage media of claim 1, wherein the time includes a time of the day, and wherein the storage media further comprises computer program logic recorded thereon for:
determining a date from other words in the text string.

11. The storage media of claim 1, wherein the text string further comprises a certain location, and wherein the at least one service comprises a navigation service to determine how long it will take the user to travel from a current location of the user to the certain location.

12. The storage media of claim 1, wherein searching the at least one service includes searching at least two information sources, each containing information of a different type.

13. The storage media of claim 1, wherein the storage media further comprises computer program logic recorded thereon for:
transmitting to the user the notification that performance of the certain activity at the certain time may be affected; or
displaying to the user the notification that performance of the certain activity at the certain time may be affected.

14. The storage media of claim 1, wherein the storage media further comprises computer program logic recorded thereon for:
upon not locating information that may affect performance of the certain activity at the certain time, creating a reminder to remind the user at the certain time to perform the certain activity.

15. The storage media of claim 1, wherein generating a notification comprises providing at least one alternative reminder item to the user.

16. The storage media of claim 15, wherein the at least one alternative reminder item changes at least one of a time, activity, date, location of the reminder item.

17. The storage media of claim 1, wherein the information is a flight status change, business hours, stock price, weather conditions, movie time, or TV show time.

18. The storage media of claim 1, wherein the notification automatically changes the reminder.

19. An electronic device, comprising:
one or more processors;
memory; and
one or more programs, wherein the one or more programs are stored in the memory and configured to be executed by the one or more processors, the one or more programs including instructions for:
receiving a text string corresponding to a natural language speech input received from a user;
processing the text string, using natural language processing, to determine that the text string includes a command to create a reminder item to remind the user at a certain time to perform a certain activity;
searching at least one service to locate information that may affect performance of the certain activity at the certain time; and
upon locating information that may affect performance of the certain activity at the certain time, generating a notification that performance of the certain activity at the certain time may be affected.

20. A computer-implemented method for providing information relating to reminders:
at an electronic device comprising a processor and memory storing instructions for execution by the processor:
receiving a text string corresponding to a natural language speech input received from a user;
processing the text string, using natural language processing, to determine that the text string includes a command to create a reminder item to remind the user at a certain time to perform a certain activity;
searching at least one service to locate information that may affect performance of the certain activity at the certain time; and
upon locating information that may affect performance of the certain activity at the certain time, generating a notification that performance of the certain activity at the certain time may be affected.
